(19) United States
(12) Patent Application Publication
(10) Pub. No.: US 2009/0157763 A1
(43) Pub. Date: Jun. 18, 2009

(54) Content validation system and method

(76) Inventors: Stefan Gottschalk, Chapel Hill, NC (US); Chris McIntosh, Mountain View, CA (US); Olivier Giroux, San Jose, CA (US); Shaun Ho, Los Altos, CA (US)

Correspondence Address: MURABITO HAO & BARNES LLP, Third Floor, Two North Market Street, San Jose, CA, 95113, US

(21) Appl. No.: 12/002,692

(22) Filed: Dec. 17, 2007

(51) Int. Cl. G06F 17/30

(52) U.S. Cl. 707/201; 707/E17.005

(57) ABSTRACT

A method and system for validating documentation. The method includes presenting a status mechanism operable to initiate a change in status of a portion of documentation, receiving a request to change the status of the portion of documentation, changing the status of the portion of documentation based on the request, and notifying an owner of the request to change the status of a portion of documentation. The method further includes presenting the portion of documentation to the owner and updating the status based on receiving a request to change the status of the portion of documentation. The system and method facilitate keeping documentation up to date.

### FIELD OF THE INVENTION

The present invention is generally related to electronic content.

### BACKGROUND OF THE INVENTION

Computers and computer networks, including the Internet, have greatly increased the availability of information. One such media of substantial importance available via computers is electronic documentation. Electronic versions of documentation have numerous advantages including no paper costs, reduced publishing costs, searchability, and easy updating.

However, despite the ease with which electronic documentation can be updated, keeping the documentation updated is difficult. The fast pace of technology development and spread of information causes documentation to quickly become outdated. For example, an employee beginning a new job may be reading internal documentation to familiarize him or herself with information concerning the company's systems and development environment. Inaccuracies in the documentation not only reduce the value of the documentation, but can defeat the purpose of the documentation itself, such as when the employee is presented inaccurate information. Furthermore, it is not practical for those in charge of the documentation to constantly check and verify the documentation.

Conventional solutions, such as wikis, have attempted to solve the out of date problem by allowing any user to add, update, and modify content. These solutions however rely heavily on users with a large variety of experience and knowledge to review and update the information in order to keep it current. The fact that any user can modify information impacts the credibility of the information. Thus, incorrect information may be added and infrequently reviewed information may be slowly updated if at all.

Thus, a need exists for a reliable way of validating documentation and keeping the documentation up to date. What is further needed is a way of notifying those in charge of the content that it is in need of review. The required system should be transparent and intuitively comprehended by the user.

### SUMMARY OF THE INVENTION

Embodiments of the present invention provide a solution that facilitates keeping up documentation or content up to date. Embodiments of the present invention further provide a mechanism for notifying users of invalid documentation or content and automatically verifying documentation.

In one embodiment, the present invention is implemented as a method for validating and invalidating documentation. The method includes presenting a status mechanism (e.g., link) operable to initiate a change in status of a portion of documentation and receiving a request to change the status of a portion of documentation. The status of the documentation is then changed corresponding to the request. If the documentation status is changed to invalid (e.g., out of date), the owner is notified. The method further includes presenting the portion of documentation to the owner and updating the status based on receiving a request to change the status.

In another embodiment, the present invention is implemented as a method for automating validation and invalidation of documentation. The method includes accessing a portion of documentation, which has an associated owner and includes a plurality of commands executable by a computer system. The commands are extracted and executed. Output from the execution is received and then verified against information of successful execution of the plurality of commands. Portions of documentation containing commands that are unsuccessful are marked as invalid. The owner or owners of the portions of documentation are then notified of the invalidity.

In this manner, embodiments of the present invention implement a reliable way for documentation to be maintained. Both the user and owners are provided with a simple mechanism (e.g., link) for marking a portion of documentation as valid or invalid. Embodiments further provide a method for automating the verification of documentation (e.g., commands) and keeping documentation up to date with external information (e.g., source code revisions).

In another embodiment, the present invention is implemented as a system for facilitating validation of documentation. The system includes a status module for maintaining the status of each of a plurality of sections of documentation and a notification module for notifying the owner of the status (e.g., invalid) of a section of documentation. The system further includes an ownership management module for maintaining information on the owner of each section of documentation and a history module for maintaining information related to the changes in status of each section of documentation.

### BRIEF DESCRIPTION OF THE DRAWINGS

The present invention is illustrated by way of example, and not by way of limitation, in the figures of the accompanying drawings and in which like reference numerals refer to similar elements.

FIG. 1 shows a computer system in accordance with one embodiment of the present invention.

FIG. 2 shows a block diagram of an exemplary graphical user interface in accordance with one embodiment of the present invention.

FIG. 3 shows a diagram of a system for validating documentation in accordance with one embodiment of the present invention.

FIG. 4 shows a flowchart of a process for validating documentation in accordance with one embodiment of the present invention.

FIG. 5 shows a flowchart of a process for automating document validation in accordance with one embodiment of the present invention.

### DETAILED DESCRIPTION OF THE INVENTION

Reference will now be made in detail to the preferred embodiments of the present invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of embodiments of the present invention, numerous specific details are set forth in order to provide a thorough understanding of the present invention. However, it will be recognized by one of ordinary skill in the art that the present invention may be practiced without these specific details. In other instances, well-known methods, procedures, components, and circuits have not been described in detail as not to unnecessarily obscure aspects of the embodiments of the present invention.

### Notation and Nomenclature:

Some portions of the detailed descriptions, which follow, are presented in terms of procedures, steps, logic blocks, processing, and other symbolic representations of operations on data bits within a computer memory. These descriptions and representations are the means used by those skilled in the data processing arts to most effectively convey the substance of their work to others skilled in the art. A procedure, computer executed step, logic block, process, etc., is here, and generally, conceived to be a self-consistent sequence of steps or instructions leading to a desired result. The steps are those requiring physical manipulations of physical quantities. Usually, though not necessarily, these quantities take the form of electrical or magnetic signals capable of being stored, transferred, combined, compared, and otherwise manipulated in a computer system. It has proven convenient at times, principally for reasons of common usage, to refer to these signals as bits, values, elements, symbols, characters, terms, numbers, or the like.

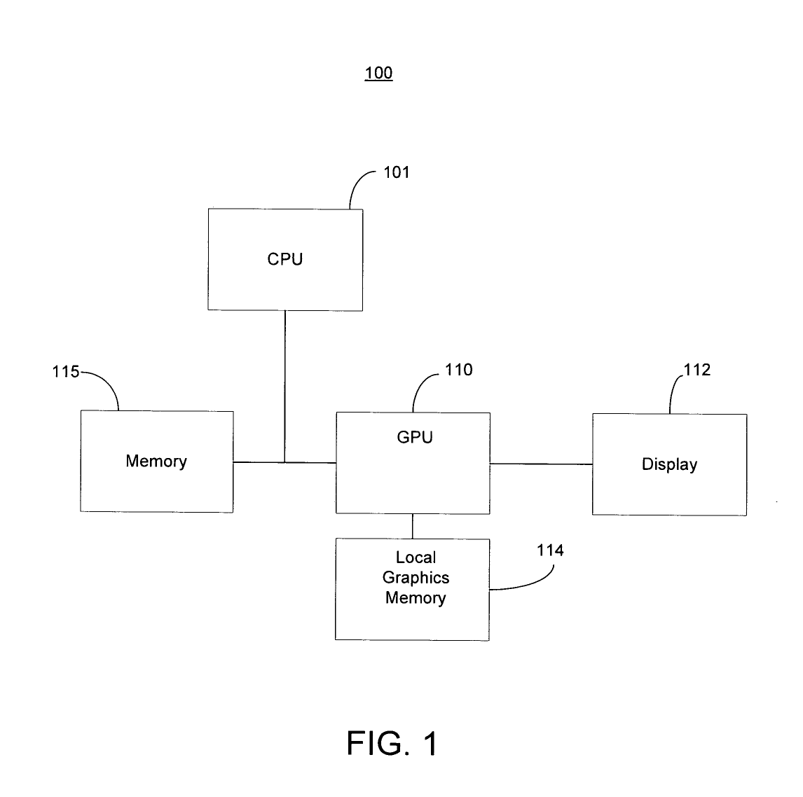

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “processing” or “accessing” or “executing” or “storing” or “rendering” or the like, refer to the action and processes of a computer system (e.g., computer system 100 of FIG. 1), or similar electronic computing device, that manipulates and transforms data represented as physical (electronic) quantities within the computer system's registers and memories into other data similarly represented as physical quantities within the computer system memories or registers or other such information storage, transmission or display devices.

### Computer System Platform:

FIG. 1 shows a computer system 100 in accordance with one embodiment of the present invention. Computer system 100 depicts the components of a basic computer system in accordance with embodiments of the present invention providing the execution platform for certain hardware-based and software-based functionality. In general, computer system 100 comprises at least one CPU 101, a system memory 115, and at least one graphics processor unit (GPU) 110. The CPU 101 can be coupled to the system memory 115 via a bridge component/memory controller (not shown) or can be directly coupled to the system memory 115 via a memory controller (not shown) internal to the CPU 101. The GPU 110 is coupled to a display 112. One or more additional GPUs can optionally be coupled to system 100 to further increase its computational power. The GPU(s) 110 is coupled to the CPU 101 and the system memory 115. The GPU 110 can be implemented as a discrete component, a discrete graphics card designed to couple to the computer system 100 via a connector (e.g., AGP slot, PCI-Express slot, etc.), a discrete integrated circuit die (e.g., mounted directly on a motherboard), or as an integrated GPU included within the integrated circuit die of a computer system chipset component (not shown). Additionally, a local graphics memory 114 can be included for the GPU 110 for high bandwidth graphics data storage.

The CPU 101 and the GPU 110 can also be integrated into a single integrated circuit die and the CPU and GPU may share various resources, such as instruction logic, buffers, functional units and so on, or separate resources may be provided for graphics and general-purpose operations. The GPU may further be integrated into a core logic component. Accordingly, any or all the circuits and/or functionality described herein as being associated with the GPU 110 can also be implemented in, and performed by, a suitably equipped CPU 101. Additionally, while embodiments herein may make reference to a GPU, it should be noted that the described circuits and/or functionality can also be implemented and other types of processors (e.g., general purpose or other special-purpose coprocessors) or within a CPU.

System 100 can be implemented as, for example, a desktop computer system or server computer system having a powerful general-purpose CPU 101 coupled to a dedicated graphics rendering GPU 110. In such an embodiment, components can be included that add peripheral buses, specialized audio/video components, IO devices, and the like. Similarly, system 100 can be implemented as a handheld device (e.g., cellphone, etc.), direct broadcast satellite (DBS)/terrestrial set-top box or a set-top video game console device such as, for example, the Xbox®, available from Microsoft Corporation of Redmond, Wash., or the PlayStation3®, available from Sony Computer Entertainment Corporation of Tokyo, Japan. System 100 can also be implemented as a “system on a chip”, where the electronics (e.g., the components 101, 115, 110, 114, and the like) of a computing device are wholly contained within a single integrated circuit die. Examples include a hand-held instrument with a display, a car navigation system, a portable entertainment system, and the like.

Embodiments of the present invention implement a reliable way for documentation to be maintained. Both the user and owners are provided with a simple mechanism (e.g., link) for marking a portion of documentation as valid or invalid and thereby notifying the owner of invalid documentation. Embodiments further provide a method for automating the verification of documentation (e.g., commands) and keeping documentation up to date with external information (e.g., source code revisions).

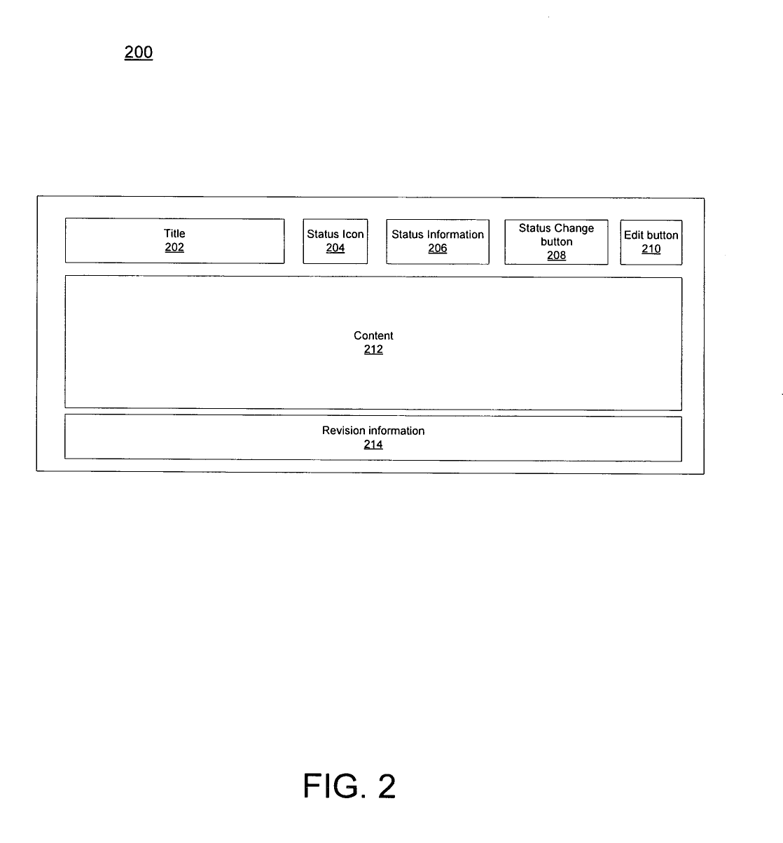

FIG. 2 shows a block diagram of an exemplary graphical user interface in accordance with one embodiment of the present invention. Exemplary graphical user interface 200 may be presented after a user has been successfully authenticated. For example, exemplary graphical user interface may be accessed or presented via web browser after logging in. Exemplary graphical user interface 200 includes title 202, status icon 204, status information 206, status change button 208, edit button 210, content 212 and revision information 214. It is appreciated that graphical user interface 200 may have additional components or fewer components. Title 202 shows the title of the section or portion of documentation. It is appreciated that documentation may be divided up in a variety of ways including, but not limited to, sections and sub-sections, portions and sub-portions, topics, chapters, pages, lines, etc.

Status information 206 reflects a plurality of status information including, but not limited to, when the last change of status occurred (e.g., the last modification date as an absolute date or a relative date) and who changed the status. Status icon 204 visually reflects the current status of the section or portion of documentation. For example, when the documentation is valid status icon 204 is shown as a green check mark and when the documentation is invalid status icon 204 is shown as a red cross mark.

Status change mechanism 208 facilitates the marking of a section of documentation as invalid. In one embodiment, status change mechanism may be a link or an icon. When status change mechanism 208 is used to mark a section of documentation as invalid, a process is initiated or triggered notifying the author or owner of the change in status of the portion of documentation. Status change mechanism 208 may further trigger the display of an area for the entry of a reason for the change of status.

Edit button 210 allows a user to access functions or other areas where the user may edit content 212 and title 202. For example, an author/owner may use the edit button to update content 212 to accurately update the documentation in response to receiving a notification of the documentation being invalid.

Content 212 is the content of the document section. In one exemplary embodiment, the content has visual clues associated with the status. For example, content 212 may be grayed out if the section has been marked as invalid.

Revision 214 includes the revision information corresponding to the documentation. For example, the revision information may correspond to the current revision of a software project such as 1.1. Revision 214 may further reflect visually the status of the object which the documentation corresponds to (e.g., if the revision has changed then revision 214 may be bright red). For example, revision 214 could be based on a time stamp which can be obtained from the file server or documents/files that are under a revision control system (e.g., CVS).

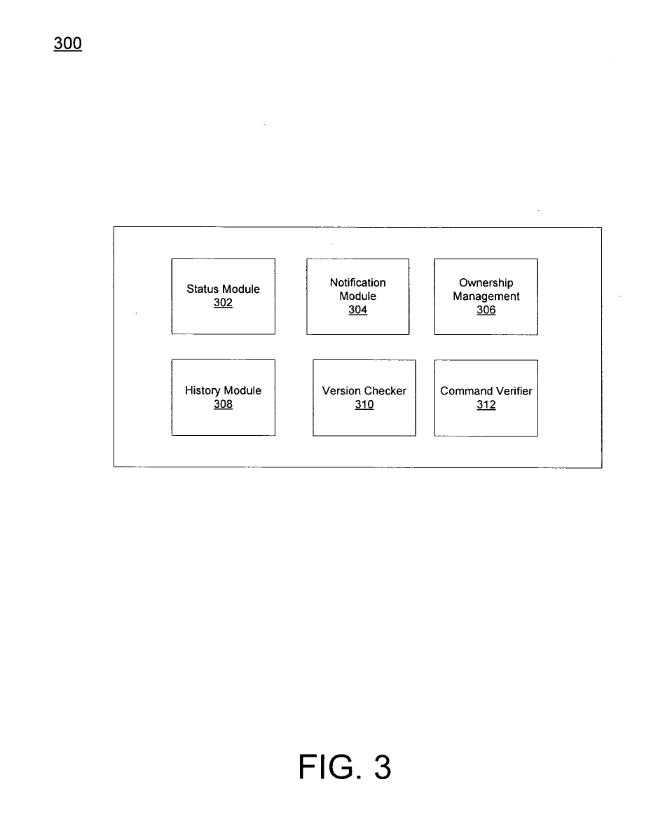

FIG. 3 shows a diagram of a system for validating documentation in accordance with one embodiment of the present invention. System 300 facilitates notification of owners and/or authors that documentation has been marked as invalid and the documentation is in need of review. System 300 further facilitates the author or owner in changing the status of the documentation back to valid. In one exemplary embodiment, system 300 facilitates the storing of a history of changes in status and corresponding information (e.g., reasons for change in status).

The FIG. 3 embodiment illustrates example components or modules that, in various embodiments, are instantiated and executed by a CPU (e.g., CPU 101 of FIG. 1) and/or a GPU (e.g., GPU 110) under the control of computer-readable and computer-executable instructions. However, it should be appreciated that the aforementioned components of system 300 can be implemented in hardware or software or in a combination of both, and that various other components or variations of the components recited in system 300 can be used to implement the functionality of embodiment of the present invention. System 300 can store various settings for each documentation section including, but not limited to, how ownership is automatically granted or removed, how validation/invalidation occurs, and how often and in what ways owners are notified of changes in documentation status.

Status module 302 maintains the status of each of a plurality of sections of documentation. In one exemplary embodiment, status module 302 stores status information with the documentation (e.g., in a SQL database).

Notification module 304 notifies the owner of the status of a section of documentation. Notification module 304 may notify the owner via email, SMS, and the like. In one exemplary embodiment, notification module 304 notifies the owner of a portion of documentation based on the change of status to invalid. It is appreciated that the status may change based on a user marking the section as invalid, an automated process (e.g., carried out by a computer), or a change triggered by an update to a database (e.g., file or source code repository). The notification may include the reason (e.g., submitted by a user, failure of command executed by the computer) for the change in status and the user who is initiating the change in status. It is appreciated that the notification may be sent out immediately or periodically (e.g., weekly) in a report format listing all the sections of documentation marked as invalid.

Notification module 304 may further take into account section settings including but not limited to, how often and in what ways owners are notified of changes in documentation status. These settings may allow notification module 304 to strike a balance between frequently notifying owners of invalid sections and burdening owners with too much documentation status changes. For example, owners of documentation that is not time-sensitive or mission critical (e.g., history of GPU development) may be notified infrequently (e.g., weekly, monthly, semi-annually). Sections of documentation that are mission critical or time-sensitive may trigger immediate or relatively frequent notification (e.g., hourly, semi-daily, or daily).

Ownership management module 306 maintains information on the owner of each section or portion of documentation. Ownership management module 306 stores the owner of a portion of documentation and can further keep track of changes in ownership. Initially, the owner of a portion or section of documentation may be the author or creator of the documentation, but as the documentation goes through various revisions, the owner may be the person who last modified the documentation, or someone specifically appointed. Ownership management module 308 may also retain the current owner when a minor change is made (e.g., fixing a typo). It is appreciated that ownership may further change based on the current owner explicitly reassigning ownership to another person or in a variety of other ways. Ownership management module 306 may support one or more owners of a portion of documentation.

Ownership management module 306 may further manage a plurality of abilities, privileges, or responsibilities assigned to users and owners. The privileges can include, but are not limited to, the ability to validate a section of documentation, the abilities to grant or remove ownership, and the responsibility to respond to a section of documentation being marked as invalid.

History module 308 maintains information related to the changes in status of each section of documentation. In one exemplary embodiment, history module 308 stores reasons associated with changes in status of each portion of documentation. For example, history module 308 stores a dialogue of changes in status between owner and those marking the documentation as invalid. History module 308 may receive the reasons of changes in status from a prompt (e.g., pop up window) in response to a user invalidating the portion of documentation. It is further appreciated that the reason may be received from a computer verifying or checking content (e.g., a command did not work) within a portion of documentation. Information stored by history module 308 may be used by notification module to include information within the notification including but not limited to, change history, reasons for changes, and the like.

Version checker 310 accesses version information associated with each portion of documentation and updates the status of portion of documentation. Each portion of documentation may have a corresponding or be associated with a particular version (e.g., version number or time stamp) of a file or portion of content. When documentation is accessed, version checker 310 may initiate a change in status of the documentation to invalid if the version of the file the documentation corresponds to has changed. Version Checker 310 may then signal notification module 304 to notify the owner. Version checker 310 may also check documentation at regularly scheduled time (e.g., early every morning).

In one exemplary embodiment, the version information is stored by a concurrent versions system (CVS). For example, the CVS may be used for software development and the version information is of an x.y.z (or x.y) format where x is a major revision, y is a minor revision, and z is a sub minor revision. Correspondingly, documentation associated with a major revision (e.g., 1.x.y) may be valid as long as the major revision number remains unchanged. Such version checking of revisions allows users (e.g., programmer) to be notified of changes in revisions and of the need to check their documentation and code is still up to date with the new version (e.g., top of tree).

System 300 further includes command verifier 312 for updating the status of a portion of documentation based on successful execution of commands within the portion of documentation. In one exemplary embodiment, command verifier 312 accesses documentation, extracts executable commands, and verifies that the commands execute properly. It is appreciated that command verifier 312 may verify commands automatically with little or no human interaction.

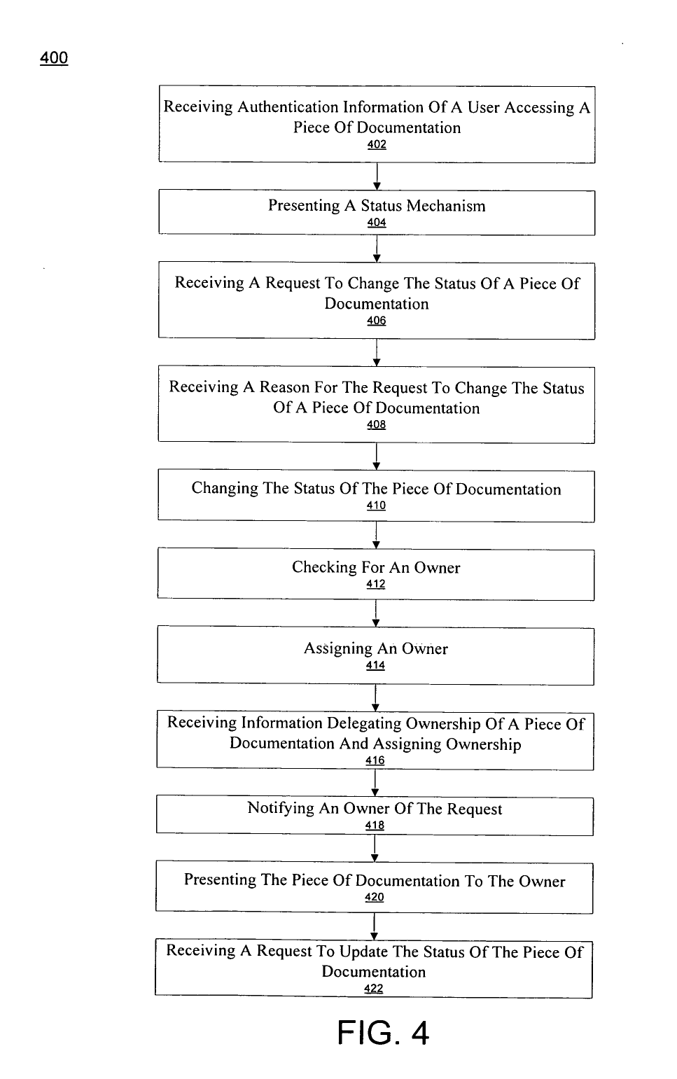

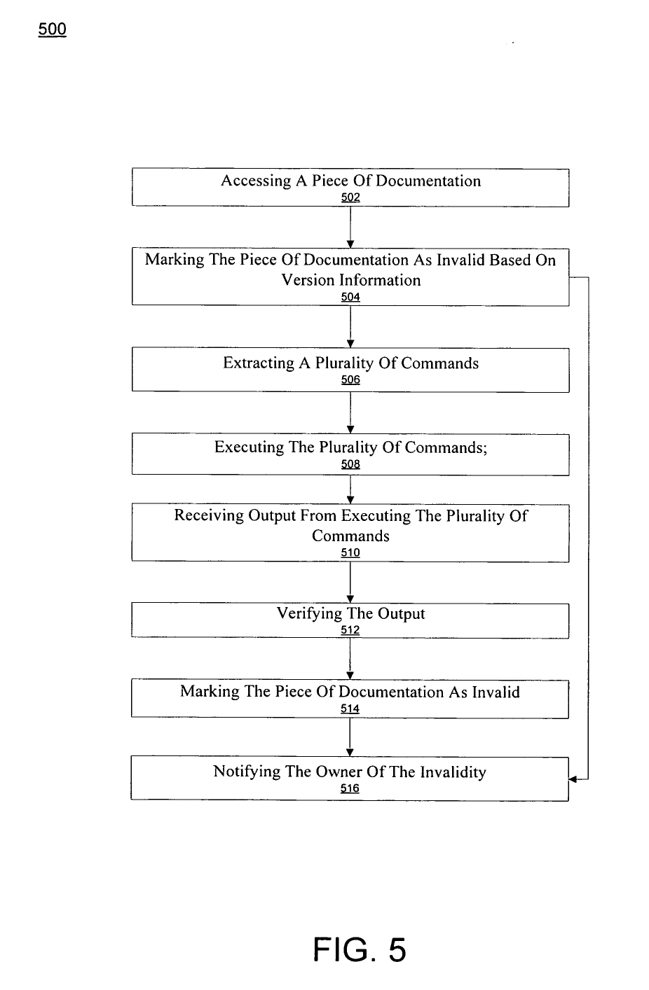

The following discussion sets forth in detail the operations of the present technology for document validation. With reference to FIGS. 4 and 5, flowcharts 400 and 500 each illustrate example blocks used by various embodiments of the present technology. Flowcharts 400 and 500 include processes that, in various embodiments, are carried out by a processor under the control of computer-readable and computer-executable instructions. Although, specific blocks are disclosed in flowcharts 400 and 500, such blocks are examples. That is, embodiments are well-suited to performing various other blocks or variations of the blocks recited in flowcharts 400 and 500. It is appreciated that the blocks in flowcharts 400 and 500 may be performed in an order different than presented, and that not all of the blocks in flowcharts 400 and 500 may be performed.

FIG. 4 shows a flowchart 400 of a process for validating documentation in accordance with one embodiment of the present invention. In one exemplary embodiment, flowchart 400 is executed on a system (e.g., system 100 or system 300) including a processor coupled to a bus and a memory coupled to the bus wherein the memory comprises instructions that when executed cause the processor to implement a method for validating documentation.

At block 402, authentication information is received for a user accessing a portion of documentation. In one exemplary embodiment, the authentication information is system login information (e.g., company wide computer login account). The authentication information may be used to track modifications and assign documentation to owners.

At block 404, a status mechanism is presented which is operable to initiate a change in status of a portion of documentation (e.g., invalid or valid). In one exemplary embodiment, the mechanism is a link (e.g., valid or invalid link) associated with each portion of documentation and presented via a web browser.

At block 406, a request is received to change the status of a portion of documentation. The request may be received via the status mechanism (e.g., link on a web page).

At block 408, a reason is received for the request to change the status of a portion of documentation. In one exemplary embodiment, a pop-up window or prompt including space for entry of a reason for invalidating a portion of documentation is presented to a user. Similarly, a reason may be entered for changing the status back to valid.

At block 410, the status of the portion of documentation is changed based on the request. In one embodiment, the status of the portion of documentation is updated in the documentation database.

At block 412, the portion of documentation is checked for an owner. Initially as the documentation is added to the system, the author will be the owner but after the documentation has been modified, the owner may be last user to modify the documentation. It is appreciated that ownership may also be checked by a script or other program.

At block 414, an owner of the portion of documentation is assigned based on the last user to modify the portion of documentation. It is appreciated that the author of the documentation may be also be the last user to modify the portion of documentation and thus also the owner. Advantageously, ownership assists users in contacting the person in charge of a portion of documentation with questions or issues. It is further appreciated that a portion of documentation can have one or more owners, and that ownership can be changed in variety of ways as described herein.

At block 416, information is received delegating ownership of a portion of documentation and assigning an owner of that portion of documentation based on the information delegating ownership. For example, owner may be assigned and the owner may receive notification of the update in ownership and the owner may respond by delegating ownership to another.

At block 418, an owner is notified of the request to change the status of a portion of documentation. For example, the owner of a portion of documentation may be notified that the portion of document has been marked as invalid. In one exemplary embodiment, the nonfiction occurs via email regularly (e.g., weekly or periodically) and includes information of the status of the owner's invalid portions of documentation.

At block 420, the portion of documentation is presented to the owner. In one exemplary embodiment, the portion of documentation may be included in the notification or accessed by a web browser operated by the owner.

At block 422, the status is updated based on receiving a request to change the status of the portion of documentation. For example, after reviewing and/or updating the documentation, the owner may change the status of the documentation back to valid.

FIG. 5 shows a flowchart of a process for automating document validation in accordance with one embodiment of the present invention. In one exemplary embodiment, flowchart 500 is executed on a system (e.g., system 100 or system 300) including a processor coupled to a bus and a memory coupled to the bus wherein the memory comprises instructions that when executed cause the processor to implement a method for validating documentation. For example, the process of flowchart 500 may be used to verify documentation regarding building and installing applications, setting up a user environment, or a project tree. The process of flowchart 500 may be used to verify commands automatically with little or no human interaction.

At block 502, a portion of documentation is accessed which has an associated owner and includes a plurality of commands executable by a computer system. In one exemplary embodiment, the plurality of commands can be executed at a terminal or command prompt (e.g., of a UNIX, Linux system, or the like).

At block 504, the portion of documentation is marked as invalid based on version information. For example, the version of source code that a portion of documentation corresponds to may be checked to see if the version matches and thus the documentation is up to date. In one exemplary embodiment, if the version of the documentation does not match the corresponding version information some additional blocks of flowchart 500 may not be performed.

At block 506, the plurality of commands are extracted from the portion of documentation. For example, the commands may have been embedded (e.g., with special tags) or described in the documentation are extracted.

At block 508, the plurality of commands is executed. In one exemplary embodiment, the commands are executed in a test environment isolated from other users' environments to preserve the other users' files.

At block 510, output is received from executing the plurality of commands. It is appreciated that output of commands may include the creation of files and folders, setting environment variables, and the like as well as success or status messages.

At block 512, the output is verified against information of successful execution of the plurality of commands. The output may be verified to ensure no error messages were received or commands that failed to complete (e.g., timed out). For example, the creation of files, folders, setting of environment variable can be verified.

At block 514, the portion of documentation is marked as invalid if execution of any of the plurality of commands is unsuccessful. In one exemplary embodiment, the portion of documentation corresponding to the command is marked as invalid (e.g., line number or command section). It is appreciated that multiple sections may be marked as invalid if a command early in a sequence of commands fails to complete successfully because success of those commands needs to be verified by an owner.

At block 516, the owner is notified of the invalidity of the portion of documentation. As described herein, the owner may be assigned based on last user to modify the documentation and may further be delegated. In one exemplary embodiment, the notification is an email including, but not limited to: the plurality of unsuccessful commands, the output of the plurality of unsuccessful commands, expected information of successful execution corresponding to the plurality of unsuccessful commands, and links to documents or other files that have changed since the documentation was last reviewed or updated.

The foregoing descriptions of specific embodiments of the present invention have been presented for purposes of illustration and description. They are not intended to be exhaustive or to limit the invention to the precise forms disclosed, and many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents.

What is claimed is:

1. A method for validating documentation, comprising:
presenting a status mechanism operable to initiate a change in status of a portion of documentation;
receiving a request to change the status of a portion of documentation;
changing the status of said portion of documentation based on said request;
notifying an owner of said request to change the status of a portion of documentation;
presenting said portion of documentation to said owner; and
updating said status based on receiving a request to change said status of said portion of documentation.

2. The method of claim 1 further comprising:
checking for an owner of said portion of documentation; and
assigning an owner of said portion of documentation based on the last user to modify said portion of documentation.

3. The method of claim 1 further comprising:
receiving information delegating ownership of a portion of documentation;
assigning an owner of said portion of documentation based on said information delegating ownership.

4. The method of claim 1 wherein said notifying occurs periodically and comprises information of the status of said owner's portions of documentation.

5. The method of claim 1 wherein said portion of documentation has one or more owners.

6. The method of claim 1 further comprising:
receiving a reason for said request to change the status of a portion of documentation.

7. The method of claim 1 further comprising:
receiving authentication information of a user accessing a portion of documentation.

8. A system comprising a processor coupled to a bus and a memory coupled to said bus wherein said memory comprises instructions that when executed cause said processor to implement a method for validating documentation, said method comprising:
accessing a portion of documentation, wherein said portion of documentation has an associated owner and comprises a plurality of commands executable by said system;
extracting said plurality of commands from said portion of documentation;
executing said plurality of commands;
receiving output from executing said plurality of commands;
verifying said output corresponds to information of successful execution of said plurality of commands;
marking said portion of documentation as invalid if execution of any of said plurality of commands is unsuccessful; and
notifying said owner of said invalidity of said portion of documentation.

9. A method as described in claim 8 wherein said plurality of commands can be executed at a terminal prompt.

10. A method as described in claim 8 wherein said notifying comprises said plurality of unsuccessful commands, said output of said plurality of unsuccessful commands, and said information of successful execution corresponding to said plurality of unsuccessful commands.

11. A method as described in claim 8 wherein said portion of documentation is associated with one or more owners.

12. A method as described in claim 8 further comprising:
marking said portion of documentation as invalid based on version information associated with said portion of documentation.

13. A method as described in claim 8 further comprising:
checking for an owner of said portion of documentation; and
assigning an owner of said portion of documentation based on the last user to modify said portion of documentation.

14. A method as described in claim 8 further comprising:
receiving information delegating ownership of a portion of documentation;
assigning an owner of said portion of documentation based on said information delegating ownership.

15. A system comprising a processor and a memory wherein said memory comprises instructions that direct said processor to facilitate document validation, said instructions comprising:
a status module for maintaining the status of each of a plurality of sections of documentation;
a notification module for notifying the owner of the status of a section of documentation;
an ownership management module for maintaining information on the owner of said section of documentation; and
a history module for maintaining information related to the changes in status of said section of documentation.

16. A system as described in claim 15 further comprising:
a version checker for accessing version information associated with said portion of documentation and for updating said status of said portion of documentation.

17. A system as described in claim 16 wherein said version information is stored by a concurrent versions system (CVS).

18. A system as described in claim 16 wherein said version information is a time stamp of a file.

19. A system as described in claim 15 further comprising:
a command verifier for updating the status of a portion of documentation based on successful execution of commands within said portion of documentation.

20. A system as described in claim 15 wherein said history module stores reasons associated with changing in status of said portion of documentation.
